(19) United States
(12) Patent Application Publication
(10) Pub. No.: US 2025/0202642 A1
(43) Pub. Date: Jun. 19, 2025

(54) Coordinating Transmission Frequency and Time Offsets for Ambient Power Devices

(71) Applicant: Cisco Technology, Inc., San Jose, CA (US)

(72) Inventors: Robert Barton, VANCOUVER (CA); Juan Carlos Zuniga, MONTREAL (CA); Indermeet Gandhi, San Jose, CA (US); Sachin D. Wakudkar, St-Sulpice (CH); Jerome Henry, Pittsboro, NC (US); Malcolm Smith, Richardson, TX (US); Matthew Silverman, Shaker Heights, OH (US)

(21) Appl. No.: 18/586,374

(22) Filed: Feb. 23, 2024

Related U.S. Application Data
(60) Provisional application No. 63/612,355, filed on Dec. 19, 2023.

(51) Int. Cl. H04L 5/00; H04W 72/0446; H04W 72/0453

(52) U.S. Cl. CPC H04L 5/0048; H04W 72/0446; H04W 72/0453

(57) ABSTRACT

Devices, networks, systems, methods, and processes for coordinating transmissions from a plurality of ambient power devices are described herein. An Access Point (AP) may transmit one or more control frames to the plurality of ambient power devices. The one or more control frames may include a sequence of bits that may be utilized by the plurality of ambient power devices to determine a frequency offset. The one or more control frames can also include a transmission order indicative of an order of transmission of each ambient power device of the plurality of ambient power devices. The one or more control frames can include one or more matrices indicative of one or more carrier frequencies and time slots. The plurality of ambient power devices can receive the one or more control frames and transmit one or more uplink frames to the AP based on the one or more control frames.

### CROSS-REFERENCE TO RELATED APPLICATION

This application claims the benefit of U.S. Provisional Patent Application No. 63/612,355, filed Dec. 19, 2023, which is incorporated by reference herein in its entirety.

The present disclosure relates to wireless communication. More particularly, the present disclosure relates to communication with ambient power devices.

### BACKGROUND

Ambient power devices refer to a new class of devices that can harvest energy from variety of sources, such as but not limited to radio waves, light, motion, heat, or any such ambient energy sources. The ambient power devices are usually small and low-cost devices that have low or no maintenance. The ambient power devices can be of various types. Some ambient power devices may be passive devices that do not include batteries. Such passive devices merely reflect energy, such as Radio Frequency (RF) waves, received in real-time or in near-real time. Some other ambient power devices can be active devices that can include capacitors or batteries to store the energy. Such active devices can delay transmission of data by utilizing the stored energy. In a dynamic landscape of a large number of devices, a combination of active devices and passive devices may be utilized. The ambient power devices can be utilized in smart grids, healthcare, home automation, factories and supply chains, etc.

In wireless networks, many ambient power devices transmit uplink frames by backscattering. In that, an ambient power device may receive a trigger frame from an Access Point (AP). The ambient power device can backscatter the trigger frame or a preamble of the trigger frame. The ambient power device may modulate a received signal, such as the RF signal or the trigger frame, by adapting one or more physical properties, such as impedance, to generate an uplink frame. Many ambient power devices are low power devices with limited or no stored energy, and limited memory, and hence, cannot perform complex signal processing. As more and more ambient power devices are deployed in a wireless communication network, challenges arise in managing transmissions from the ambient power devices. In uplink, if multiple ambient power devices transmit the uplink frames simultaneously, collisions and loss of data can be caused due to overlapping uplink frames from different ambient power devices.

Therefore, there is a need for a system to distribute transmissions from the ambient power devices such that the collisions are avoided or minimized. There is also a need for a technique for effectively integrating the ambient power devices in existing wireless communication networks.

### SUMMARY OF THE DISCLOSURE

Systems and methods for coordinating transmissions from multiple ambient power devices in accordance with embodiments of the disclosure are described herein. In some embodiments, a transmission coordination logic is configured to determine one or more carrier frequencies, determine one or more time slots associated with the one or more carrier frequencies, generate a control frame based on the one or more carrier frequencies or the one or more time slots, and transmit the control frame to one or more ambient power devices.

In some embodiments, the transmission coordination logic is further configured to receive one or more uplink frames from the one or more ambient power devices in response to the control frame.

In some embodiments, the transmission coordination logic is further configured to transmit a multi-user bulk acknowledgement frame to the one or more ambient power devices in response to the one or more uplink frames.

In some embodiments, each ambient power device of the one or more ambient power devices determines a frequency offset based on the control frame and transmits an uplink frame of the one or more uplink frames based on the frequency offset.

In some embodiments, the one or more ambient power devices transmit the one or more uplink frames by backscattering the control frame.

In some embodiments, the one or more ambient power devices are energized or triggered by the control frame to transmit the one or more uplink frames.

In some embodiments, the transmission coordination logic is further configured to determine a transmission order based on the one or more time slots, wherein the control frame includes the transmission order.

In some embodiments, each ambient power device of the one or more ambient power devices transmits an uplink frame of the one or more uplink frames based on the transmission order.

In some embodiments, the transmission coordination logic is further configured to generate a matrix of the one or more carrier frequencies and the one or more time slots, wherein the control frame includes the matrix.

In some embodiments, the one or more ambient power devices transmit the one or more uplink frames based on the matrix.

In some embodiments, the transmission coordination logic is further configured to generate one or more matrices indicative of the one or more carrier frequencies and the one or more time slots, assign a matrix of the one or more matrices to an ambient power device of the one or more ambient power devices, generate one or more control frames including the one or more matrices, and transmit the control frame of the one or more control frames to corresponding ambient power device of the one or more ambient power devices.

In some embodiments, each ambient power device of the one or more ambient power devices transmits an uplink frame of the one or more uplink frames based on corresponding matrix of the one or more matrices.

In some embodiments, each ambient power device of the one or more ambient power devices selects a carrier frequency of the one or more carrier frequencies for transmitting an uplink frame of the one or more uplink frames based on a random value.

In some embodiments, each ambient power device of the one or more ambient power devices selects a carrier frequency of the one or more carrier frequencies for transmitting an uplink frame of the one or more uplink frames based on a predetermined hash value.

In some embodiments, a transmission coordination logic is configured to generate a matrix of one or more carrier frequencies and one or more time slots, generate a control frame including the matrix, and transmit the control frame to one or more ambient power devices.

In some embodiments, each ambient power device of the one or more ambient power devices transmits an uplink frame in response to the control frame based on the matrix.

In some embodiments, the transmission coordination logic is further configured to determine a transmission order based on the one or more time slots, wherein the control frame is indicative of the transmission order.

In some embodiments, each ambient power device of the one or more ambient power devices transmits an uplink frame based on the transmission order.

In some embodiments, determining one or more carrier frequencies includes determining one or more time slots associated with the one or more carrier frequencies, generating a control frame based on the one or more carrier frequencies or the one or more time slots, and transmitting the control frame to one or more ambient power devices.

In some embodiments, determining one or more carrier frequencies further includes receiving one or more uplink frames from the one or more ambient power devices in response to the control frame, and transmitting a multi-user bulk acknowledgement frame to the one or more ambient power devices in response to the one or more uplink frames.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of transmission of frames in a wireless communication network, in accordance with various embodiments of the disclosure;

FIG. 3 is a conceptual network diagram of various environments that a transmission coordinator may operate on a plurality of network devices, in accordance with various embodiments of the disclosure;

FIG. 4 is a flowchart depicting a process for transmitting one or more control frames by an Access Point (AP), in accordance with various embodiments of the disclosure;

FIG. 5 is a flowchart depicting a process for processing one or more control frames by one or more ambient power devices, in accordance with various embodiments of the disclosure;

FIG. 6 is a flowchart depicting a process for generating a matrix, in accordance with various embodiments of the disclosure; and

FIG. 7 is a conceptual block diagram of a device suitable for configuration with a transmission coordination logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that coordinate transmissions from multiple ambient power devices. A communication network may comprise an Access Point (AP) and one or more ambient power devices. The ambient power devices can be in communication with the AP by way of one or more Radio Frequency (RF) channels. The RF channels may include multiple bands of frequencies. In some embodiments, for example, the bands of frequencies may include Wi-Fi bands such as but not limited to 2.4 GHZ, 5 GHz, or 6 GHz. Some more examples can include millimeter-wave (mmWave) bands. Additional examples can include Sub-1 GHz band frequencies. The ambient power devices can be powered by one or more energy sources such as, but not limited to, radio waves, light, motion, heat, or any such ambient energy sources. In many embodiments, the AP may determine one or more carrier frequencies. The carrier frequencies can be indicative of the RF channels utilized to communicate with the ambient power devices. The carrier frequencies may be indicative of one or more uplink channels, downlink channels, or both. The AP can inform the ambient power devices of the carrier frequencies when the ambient power devices associate with the AP. In some embodiments, for example, the AP may utilize Frequency Division Multiple Access (FDMA) or other such techniques to determine the carrier frequencies. The AP can determine one or more time slots associated with the carrier frequencies. The AP may determine the available time slots for an ambient power device such that transmissions by the ambient power device on the available time slots do not collide or interfere with transmissions from other ambient power devices. In certain embodiments, for example, the AP can utilize Time Division Multiple Access (TDMA) or other such techniques to determine the time slots. Thereafter, the AP may generate one or more control frames based on the carrier frequencies and/or the time slots. In more embodiments, for example, the control frames can be trigger frames, data frames, or charging frames. In numerous embodiments, for example, the trigger frames can be utilized to signal a beginning of transmission of the uplink frames. The charging frames may be utilized to charge a battery or a capacitor in the ambient power devices, for example. The data frames can be downlink data frames utilized to transmit data to the ambient power devices, for example. In some more embodiments, the control frames may be indicative of resource allocation to the ambient power device, for example. In numerous embodiments, the control frames can be indicative of the carrier frequencies and/or the time slots. In some embodiments, the control frame can be transmitted by the AP to the ambient power devices or can be relayed to the ambient power devices through one or more wireless devices. Upon receiving a control frame, an ambient power device may transmit an uplink frame to the AP in response to the control frame. In many further embodiments, the ambient power device may generate the uplink frame by backscattering the control frame or a preamble in the control frame. In certain embodiments, the ambient power device may utilize one or more techniques such as but not limited to Long Range (LoRa) backscatter, Chirp Spread Spectrum (CSS) modulation, or amplitude/phase modulation, or other such modulation techniques etc. for example to backscatter and transmit the uplink frame. The uplink frame may be indicative of data or a value of a physical quantity measured by the ambient power device. In still more embodiments, for example, the ambient power devices can be temperature sensors, humidity sensors, or pressure sensors, etc. that may transmit temperature values, humidity values, or pressure values, etc. In response to receiving the uplink frame, the AP can transmit an acknowledgment frame to the ambient power device. In many additional embodiments, the AP may receive multiple uplink frames from multiple ambient power devices. In that case, the AP can transmit a multi-user acknowledgement frame to the multiple ambient power devices. In still further embodiments, the acknowledgement frame or the multi-user acknowledgement frame can be indicative of the AP receiving the data transmitted by the multiple ambient power devices.

In a number of embodiments, the AP may coordinate the transmissions from the ambient power devices in frequency domain. In that, the control frame can include a sequence of bits. The ambient power device can determine a frequency offset based on the sequence of bits in the control frame. The sequence of bits can be a predetermined sequence of bits or can be dynamically generated by the AP. In some embodiments, different control frames can include different sequence of bits. In some more embodiments, the AP can dynamically modify or change the sequence of bits based on the changes in network conditions or changes in topology of the ambient power devices, etc. In certain embodiments, the AP may determine different sequence of bits for different ambient power devices. In more embodiments, the sequence of bits may vary with variations in the carrier frequencies. The frequency offset can be Carrier Frequency Offset (CFO), for example. In some embodiments, the sequence of bits can also be utilized by the ambient power device to determine a phase offset. In numerous embodiments, the ambient power device may transmit the uplink frame at a frequency that is shifted from the carrier frequency based on the frequency offset. In that, different ambient power devices can transmit at different shifted frequencies based on different frequency offsets. This may facilitate in reducing collisions between the different ambient power devices. In further embodiments, for example, the different ambient power devices may reach corresponding predetermined charge levels at same time, and hence, may be ready for transmission of the uplink frames at the same time. In that case, collisions can be avoided by shifting the frequencies of the transmissions of the uplink frames. Upon determining the frequency offset, the ambient power device may synchronize with the one or more carrier frequencies or the shifted frequencies. Thereafter, the ambient power device can transmit the uplink frame at the one or more carrier frequencies or the shifted frequencies.

In various embodiments, the AP can coordinate the transmissions from the ambient power devices in time domain. In that, the AP may determine a transmission order for the ambient power devices. The transmission order, in conjunction with the time slots, can be utilized by the ambient power devices to determine a time for transmission of the uplink frames or a Transmission Opportunity (TXOP) for uplink transmission. The TXOP may be indicative of the time slots in which the ambient power devices can transmit the uplink frames with no congestion or minimal congestion. In some embodiments, the AP can determine the transmission order such that the transmissions from the ambient power devices may be staggered within the TXOP. In that, the AP can organize the transmissions from different ambient power devices in distinct time slots separated by Short Inter-Frame Space (SIFS). These time slots can be across the multiple RF channels. Some ambient power devices may have simple transmission capabilities, and hence, may not support triggered uplink Multi-User (MU) Physical Layer Protocol Data Unit (PPDU) transmission. For such ambient power devices, the transmission order can be especially beneficial to determine an order in which each ambient power device can transmit in the TXOP. The control frame may comprise the transmission order. In certain embodiments, the control frame may be indicative of the transmission order. In operation, the ambient power devices can receive the control frame and determine the transmission order based on the control frame. Thereafter, the ambient power devices may transmit the uplink frames based on the transmission order. In additional embodiments, the ambient power devices may skip transmission if the ambient power devices do not have any data or uplink frames for transmission.

In additional embodiments, the AP may coordinate the transmissions from the ambient power devices in a combination of the frequency and time domains. In that, the AP can generate a matrix of the carrier frequencies and the time slots. The control frame may comprise the matrix. In some embodiments, the control frame can be indicative of the matrix. Each element of the matrix may be indicative of a combination of a specific time slot and a specific carrier frequency or RF channel. Each ambient power device can utilize the matrix to transmit the uplink frame based on one of the elements of the matrix. In certain embodiments, the matrix can be agreed upon beforehand, for example, the AP may transmit the matrix to the ambient power devices when the ambient power devices associate with the AP, or the matrix can be configured in the ambient power devices. In more embodiments, the AP may dynamically generate the matrix and transmit the matrix to the ambient power devices. In this case, the AP can dynamically modify size or content of the matrix based on one or more dynamic changes in network topology or network conditions. The AP may dynamically transmit the size of the matrix to the ambient power devices. The ambient power devices can select the one or more time slots or the one or more carrier frequencies based on the size of the matrix. The AP may transmit different sizes of the matrix to different ambient power devices to avoid collisions between the transmissions from the different ambient power devices. Similarly, the AP can group a set of ambient power devices and transmit the matrix or the size of the matrix to the set of ambient power devices. Further, the AP may transmit different sizes of the matrix to different sets of ambient power devices to avoid collisions between the transmissions from the different sets of ambient power devices. In some more embodiments, the AP can transmit a single matrix to multiple ambient power devices. In numerous embodiments, the AP may generate multiple matrices indicative of the carrier frequencies and the time slots. The AP can assign a different matrix to each ambient power device or to a set of ambient power devices. The AP may generate multiple control frames indicative of the matrices. Accordingly, the AP can transmit a control frame indicative of a different matrix to each ambient power device or can transmit a control frame indicative of a different matrix to each set of ambient power devices. In operation, the ambient power devices can receive the matrix and determine the carrier frequency and the time slot based on the matrix. Thereafter, the ambient power devices may transmit the uplink frames based on the carrier frequency and the time slot.

In further embodiments, the ambient power devices can select one of the carrier frequencies based on a random value. In some embodiments, the ambient power devices may utilize a random number engine or a random number generator circuit to generate the random value. In some more embodiments, the random value or a set of random values may be configured in the ambient power devices. In certain embodiments, the random value can be communicated by the AP. In that, the ambient power devices may generate a random number to facilitate selection of the carrier frequency. In some embodiments, the ambient power devices can select one of the carrier frequencies based on a hash value. In that, the hash value can be agreed upon beforehand, for example, the AP may transmit the hash value to the ambient power devices when the ambient power devices associate with the AP, or the hash value and a table can be configured in the ambient power devices. In numerous embodiments, one or more hash values may be preconfigured in the ambient power device by a vendor or manufacturer at the time of manufacturing the ambient power device. In some more embodiments, the ambient power device may compute the one or more hash values based on a Media Access Control (MAC) address. In more embodiments, the AP may dynamically generate the hash value and transmit the hash value to the ambient power devices. In certain embodiments, the ambient power devices can choose one of the carrier frequencies during initialization and utilize the chosen carrier frequency for subsequent communication with the AP.

Advantageously, the AP can coordinate transmissions from the multiple ambient power devices such that collisions are minimized. The AP may allocate the carrier frequencies and the time slots to the ambient power devices to optimize resource utilization. The AP can dynamically modify or alter the transmission order based on changes in the network conditions or changes in topology of the ambient power devices. The AP may utilize time domain, frequency domain, or the combination of time and frequency domains to stagger the transmissions from the ambient power devices in the TXOP. The communication network of the present disclosure can effectively implement the transmission order of the ambient power devices with little to none processing capabilities. The transmission coordination technique of the present disclosure can energize the ambient power devices and also facilitate derivation and compensation of the frequency offsets by the ambient power devices. The communication network of the present disclosure ensures reliable wireless communication and optimal utilization of radio resources in dynamic environments.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

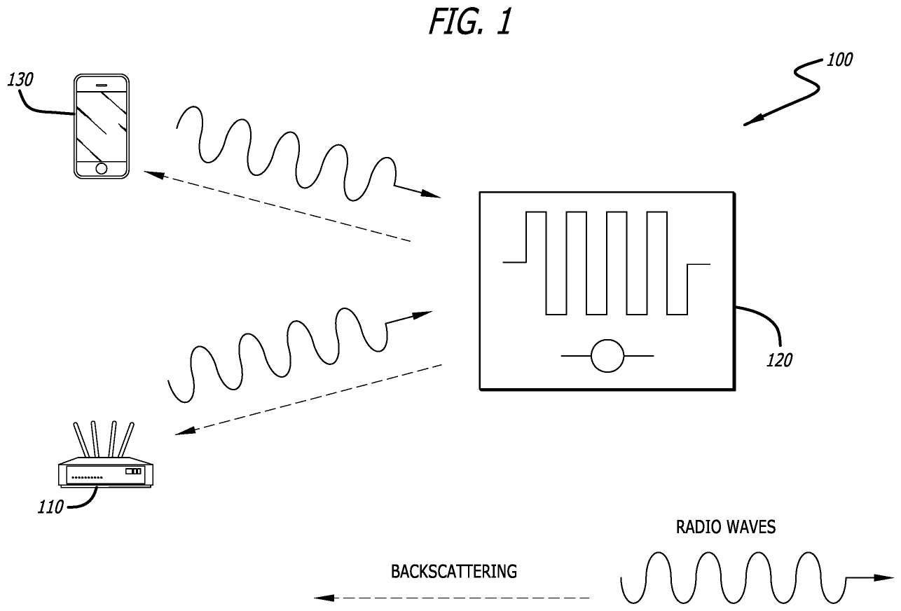

Referring to FIG. 1, a conceptual illustration of a wireless communication network 100, in accordance with various embodiments of the disclosure is shown. In many embodiments, the wireless communication network 100 may include an Access Point (AP) 110, an ambient power device 120, and a wireless device 130. The ambient power device 120 may be powered by one or more energy sources such as, but not limited to, radio waves, light, motion, heat, or any such ambient energy sources. The ambient power device 120 may be an active device, i.e., with energy storage capacity such as a battery or a capacitor etc. or a passive device. The ambient power device 120 can receive one or more Radio Frequency (RF) signals. The ambient power device 120 may backscatter the RF signals. In some embodiments, the ambient power device 120 can modulate and backscatter incident RF signals. In certain embodiments, the ambient power device 120 can be in communication with the AP 110 by utilizing Wi-Fi bands such as but not limited to 2.4 GHZ, 5 GHz, or 6 GHz. Some more examples can include millimeter-wave (mmWave) bands. Additional examples can include Sub-1 GHz band frequencies. Examples of the backscatter communication between the ambient power device 120, the AP 110, and the wireless device 130 include but are not limited to monostatic backscatter, bistatic backscatter, and ambient backscatter. The wireless device 130 may function as a receiver for backscatter transmission from the ambient power device 120. Examples of the wireless device 130 include but are not limited to smartphone, tablet, computer, an RF Identification (RFID) tag reader, etc. In certain embodiments, for example, the ambient power device 120 may be associated with a consumer electronic device or an Internet of Things (IoT) enabled device.

In a number of embodiments, the AP 110 may transmit one or more frames to the ambient power device 120. Examples of the frames include but are not limited to charging frames, trigger frames, control frames, management frames, or beacon frames etc. In some embodiments, for example, the trigger frames can be utilized to signal the ambient power device 120 to transmit an uplink frame. The charging frames may be utilized to charge the battery or the capacitor in the ambient power device 120, for example. The data frames can be downlink data frames utilized to transmit data to the ambient power device 120, for example. In some more embodiments, the control frames may be indicative of resource allocation to the ambient power device 120, for example. The ambient power device 120 can transfer one or more uplink frames to the AP 110 and/or the wireless device 130.

In various embodiments, the AP 110 can transmit a control frame to the ambient power device 120. The control frame may include a sequence of one or more bits. The sequence of bits can be a predetermined sequence of bits or can be dynamically generated by the AP 110. In some embodiments, different control frames can include different sequence of bits. In some more embodiments, the AP 110 can dynamically modify or change the sequence of bits based on the changes in network conditions or changes in topology of the ambient power devices, etc. In certain embodiments, the AP 110 may determine different sequence of bits for different ambient power devices. In more embodiments, the sequence of bits may vary with variations in the carrier frequencies. The ambient power device 120 may determine a frequency offset based on the sequence of bits in the control frame. The frequency offset can be Carrier Frequency Offset (CFO), for example. In many more embodiments, the ambient power device can also determine a phase offset based on the sequence of bits. In numerous embodiments, the ambient power device 120 may transmit the uplink frame at a frequency that is shifted from the carrier frequency based on the frequency offset. In that, different ambient power devices can transmit at different shifted frequencies based on different frequency offsets. This may facilitate in reducing collisions between the different ambient power devices. In further embodiments, for example, the different ambient power devices may reach corresponding predetermined charge levels at same time, and hence, may be ready for transmission of the uplink frames at the same time. In that case, collisions can be avoided by shifting the frequencies of the transmissions of the uplink frames. Upon determining the frequency offset, the ambient power device 120 may synchronize with the one or more carrier frequencies or the shifted frequencies. Thereafter, the ambient power device 120 can transmit the uplink frame at the one or more carrier frequencies or the shifted frequencies.

In additional embodiments, the ambient power device 120 may select the carrier frequency from a set of carrier frequencies based on a random value. In some embodiments, the ambient power device 120 may utilize a random number engine or a random number generator circuit to generate the random value. In some more embodiments, the random value or a set of random values may be configured in the ambient power device 120. In certain embodiments, the random value can be communicated by the AP 110. The set of carrier frequencies can be dynamically received from the AP 110 or may be preconfigured within the ambient power device 120. In more embodiments, the ambient power device 120 can select the carrier frequency from the set of carrier frequencies based on a hash value. The hash value can be dynamically communicated by the AP 110 or the hash value and a hash table can be stored within the ambient power device 120. In numerous embodiments, one or more hash values may be preconfigured in the ambient power device 120 by a vendor or manufacturer at the time of manufacturing the ambient power device 120. In some more embodiments, the ambient power device 120 may compute the one or more hash values based on a Media Access Control (MAC) address.

In further embodiments, the AP 110 can transmit a control frame to the ambient power device 120. The control frame may be indicative of a transmission order in a Transmission Opportunity (TXOP) for uplink transmission. The control frame can also be further indicative of a time slot in the TXOP. The ambient power device 120 may receive the control frame and determine an order associated with the ambient power device 120 based on the transmission order. Based on the determined order, the ambient power device 120 can transmit the uplink frame in the TXOP. In some embodiments, the uplink frames from multiple ambient power devices including the ambient power device 120 may be separated by Short Inter-Frame Space (SIFS). In additional embodiments, the ambient power device 120 may skip transmission if the ambient power device 120 does not have any data or uplink frames for transmission.

In many more embodiments, the control frame can be indicative of a matrix or a size of the matrix. The matrix may include one or more elements indicative of one or more transmission slots and one or more carrier frequencies. The ambient power device 120 can determine the time slot and the carrier frequency for transmitting the uplink frame based on the matrix or the size of the matrix. Based on the time slot and the carrier frequency, the ambient power device 120 can transmit the uplink frame.

In many additional embodiments, upon receiving the uplink frame, the AP 110 may transmit an acknowledgement frame to the ambient power device 120. When the AP 110 receives multiple uplink frames from multiple ambient power devices, the AP 110 can transmit a single multi-user bulk acknowledgement frame to the multiple ambient power devices. The acknowledgement frame or the multi-user bulk acknowledgement frame can be indicative of the AP 110 receiving the data transmitted by the multiple ambient power devices.

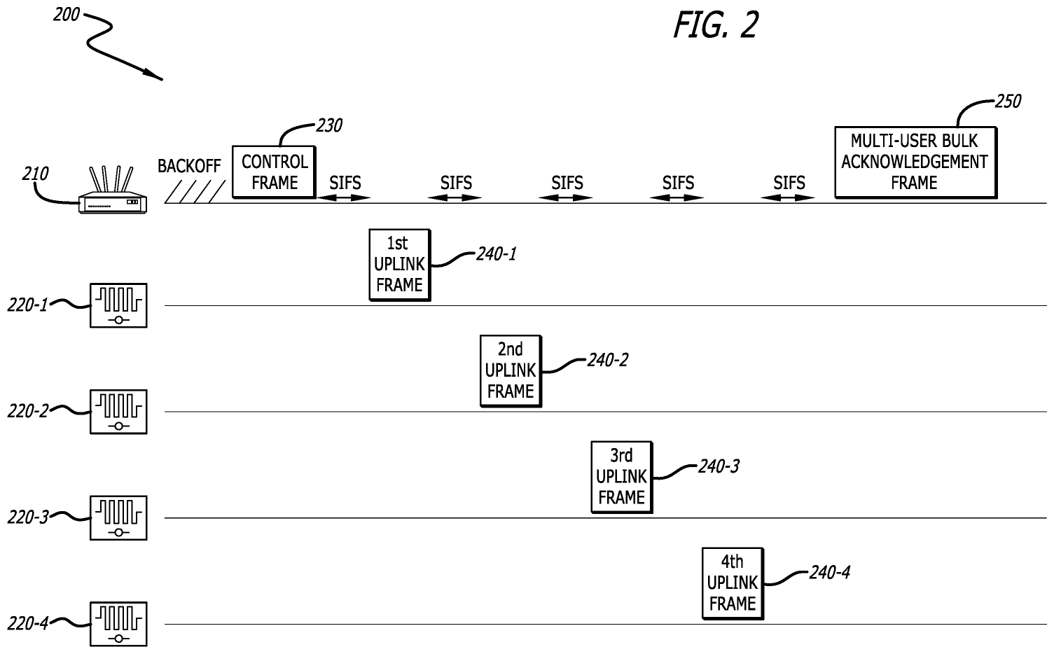

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, the AP 110 may dynamically allocate radio resources to a plurality of ambient power devices such that the collisions between the uplink frames from the plurality of ambient power devices are minimized or avoided. The elements depicted in FIG. 1 may also be interchangeable with other elements of FIGS. 2-7 as required to realize a particularly desired embodiment.

Referring to FIG. 2, a conceptual illustration of transmission of frames in a wireless communication network 200, in accordance with various embodiments of the disclosure is shown. In many embodiments, the wireless communication network 200 may include an AP 210 and a plurality of ambient power devices 220 including first through fourth ambient power devices 220-1 to 220-4. The AP 210 can transmit a control frame to the plurality of ambient power devices 220. In some embodiments, the control frame may include the sequence of one or more bits. The plurality of ambient power devices 220 can determine the frequency offset based on the sequence of bits in the control frame. Thereafter, the plurality of ambient power devices 220 can transmit at one or more shifted frequencies based on the frequency offset. In certain embodiments, the control frame may be indicative of the transmission order in TXOP for uplink transmission. The first through fourth ambient power devices 220-1 to 220-4 may receive the control frame and determine corresponding order associated with the first through fourth ambient power devices 220-1 to 220-4 based on the transmission order. In more embodiments, the control frame can be indicative of the matrix or the size of the matrix. The matrix may include the elements indicative of one or more transmission slots and one or more carrier frequencies. The plurality of ambient power devices 220 can determine the time slot and the carrier frequency for transmitting the uplink frames based on the matrix or the size of the matrix.

In a number of embodiments, the first through fourth ambient power devices 220-1 to 220-4 may transmit first through fourth uplink frames 240-1 to 240-4 respectively. Each uplink frame of the first through fourth uplink frames 240-1 to 240-4 can be separated by the SIFS. Upon receiving the first through fourth uplink frames 240-1 to 240-4, the AP 210 may transmit a multi-user bulk acknowledgement frame 250 to the plurality of ambient power devices 220. The multi-user bulk acknowledgement frame 250 can be indicative of the AP 210 receiving the first through fourth uplink frames 240-1 to 240-4.

Although a specific embodiment for the transmission of frames in the wireless communication network 200 for carrying out the various steps, processes, methods, and operations described herein is discussed with respect to FIG. 2, any of a variety of systems and/or processes may be utilized in accordance with embodiments of the disclosure. For example, the AP 210 can also dynamically transmit other type of frames such as charging frames or trigger frames to the plurality of ambient power devices 220. The elements depicted in FIG. 2 may also be interchangeable with other elements of FIG. 1 and FIGS. 3-7 as required to realize a particularly desired embodiment.

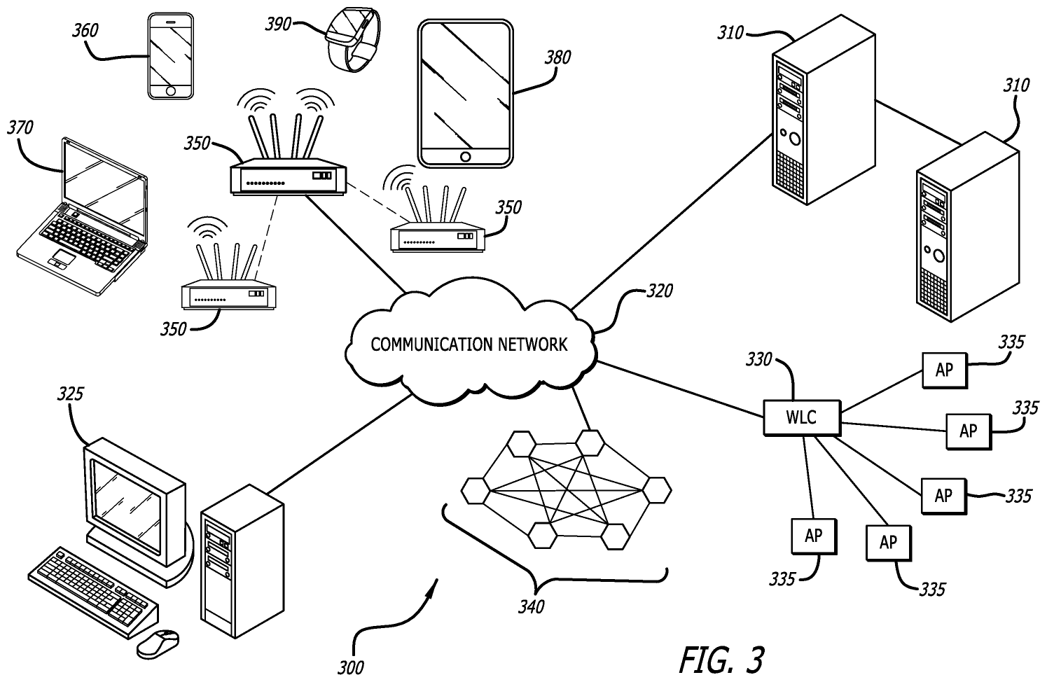

Referring to FIG. 3, a conceptual network diagram 300 of various environments that a transmission coordinator may operate on a plurality of network devices, in accordance with various embodiments of the disclosure is shown. Those skilled in the art will recognize that the transmission coordinator can be comprised of various hardware and/or software deployments and can be configured in a variety of ways. In many embodiments, the transmission coordinator can be configured as a standalone device, exist as a logic in another network device, be distributed among various network devices operating in tandem, or remotely operated as part of a cloud-based network management tool. In further embodiments, one or more servers 310 can be configured with or otherwise operate the transmission coordinator. In many embodiments, the transmission coordinator may operate on one or more servers 310 connected to a communication network 320. The communication network 320 can include wired networks or wireless networks. In many embodiments, the communication network 320 may be a Wi-Fi network operating on various frequency bands, such as, 2.4 GHz, 5 GHz, or 6 GHz. In further embodiments, the transmission coordinator operating on the servers 310 can facilitate in scheduling transmissions from one or more ambient power devices. The transmission coordinator can be provided as a cloud-based service that can service remote networks, such as, but not limited to a deployed network 340. In many embodiments, the transmission coordinator can be a logic that coordinates with the one or more ambient power devices to facilitate staggered transmission of the uplink frames separated by the SIFS in the TXOP.

However, in additional embodiments, the transmission coordinator may be operated as a distributed logic across multiple network devices. In the embodiment depicted in FIG. 3, a plurality of APs 350 can operate as the transmission coordinator in a distributed manner or may have one specific device operate as the transmission coordinator for all of the neighboring or sibling APs 350. The APs 350 facilitate Wi-Fi connections for various electronic devices, such as but not limited to mobile computing devices including laptop computers 370, cellular phones 360, portable tablet computers 380 and wearable computing devices 390.

In further embodiments, the transmission coordinator may be integrated within another network device. In the embodiment depicted in FIG. 3, a wireless LAN controller (WLC) 330 may have an integrated transmission coordinator that the WLC 330 can use to manage the uplink transmissions within the various APs 335 that the WLC 330 is connected to, either wired or wirelessly. In still more embodiments, a personal computer 325 may be utilized to access and/or manage various aspects of the transmission coordinator, either remotely or within the network itself. In the embodiment depicted in FIG. 3, the personal computer 325 communicates over the communication network 320 and can access the transmission coordinator of the servers 310, or the network APs 350, or the WLC 330.

Although a specific embodiment for various environments that the transmission coordinator may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the transmission coordinator may be provided as a device or software separate from the network devices or the transmission coordinator may be integrated into the network devices. The elements depicted in FIG. 3 may also be interchangeable with other elements of FIGS. 1-2 and 4-7 as required to realize a particularly desired embodiment.

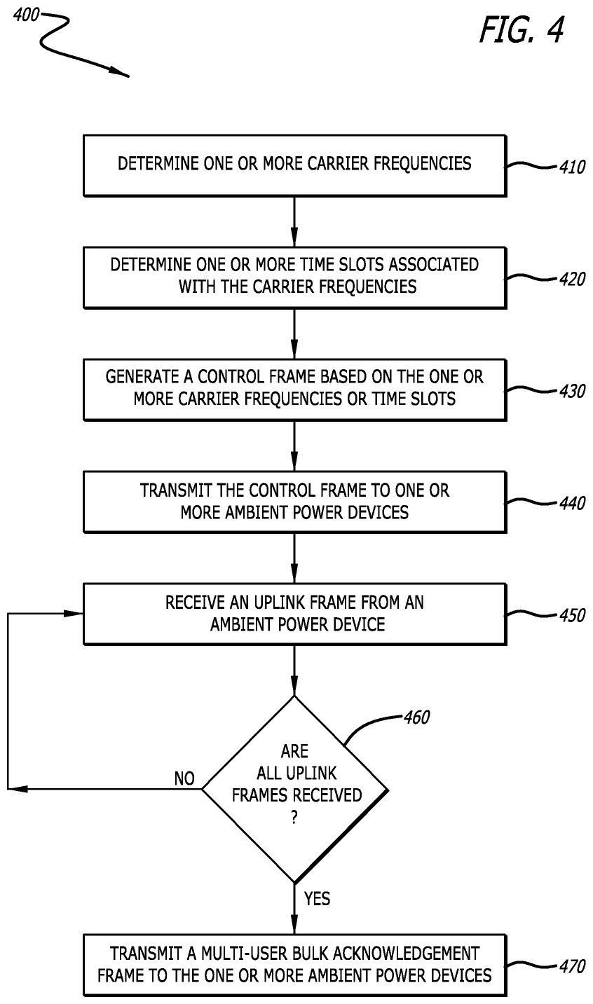

Referring now to FIG. 4, a flowchart depicting a process 400 for transmitting the control frames by the AP, in accordance with various embodiments of the disclosure is shown. In many embodiments, the process 400 may determine the one or more carrier frequencies (block 410). In some embodiments, the carrier frequencies can be indicative of the RF channels utilized by the process 400 implemented by the AP to communicate with the ambient power devices. In certain embodiments, the carrier frequencies may be indicative of one or more uplink channels, downlink channels, or both. In more embodiments, the process 400 can inform the ambient power devices of the carrier frequencies when the ambient power devices associate with the AP. In some more embodiments, for example, the process 400 may utilize Frequency Division Multiple Access (FDMA) or other such techniques to determine the carrier frequencies.

In a number of embodiments, the process 400 can determine the one or more time slots associated with the carrier frequencies (block 420). In some embodiments, the process 400 may determine the available slots for the ambient power device such that transmissions by the ambient power device on the available time slots do not collide or interfere with transmissions from other ambient power devices. In certain embodiments, for example, the process 400 can utilize Time Division Multiple Access (TDMA) or other such techniques to determine the time slots.

In various embodiments, the process 400 may generate the control frame based on the one or more carrier frequencies and time slots (block 430). In some embodiments, for example, the control frames can be trigger frames, data frames, or charging frames. In certain embodiments, for example, the trigger frames can be utilized to signal the beginning of transmission of the uplink frames. In more embodiments, for example, the charging frames may be utilized to charge the battery or the capacitor in the ambient power devices, for example. In some more embodiments, the data frames can be downlink data frames utilized to transmit data to the ambient power devices, for example. In numerous embodiments, the control frames may be indicative of resource allocation to the ambient power device, for example. In many further embodiments, the control frames can be indicative of the carrier frequencies and/or the time slots.

In additional embodiments, the process 400 can transmit the control frame to the one or more ambient power devices (block 440). In some embodiments, the control frame can be transmitted by the AP to the ambient power devices or can be relayed to the ambient power devices through one or more wireless devices. In certain embodiments, the process 400 may generate and transmit a different control frame to each ambient power device or may generate and transmit a single control frame to the multiple ambient power devices. In more embodiments, the control frame may comprise the preamble and a payload.

In further embodiments, the process 400 may receive an uplink frame from one of the plurality of ambient power devices (block 450). In some embodiments, the ambient power device can transmit the uplink frame by backscattering the received control frame. In certain embodiments, the ambient power device may utilize one or more techniques such as but not limited to Long Range (LoRa) backscatter, Chirp Spread Spectrum (CSS) modulation, or amplitude/phase modulation, or other such modulation techniques etc. for example to backscatter and transmit the uplink frame.

In many more embodiments, the process 400 can check if the uplink frames from all the ambient power devices have been received (block 460). In some embodiments, the process 400 may associate the received uplink frame with the one of the plurality of ambient power devices based on the transmission order in the TXOP. Thereafter, in certain embodiments, the process 400 can determine which of the plurality of ambient power devices have not yet transmitted the corresponding uplink frames. In more embodiments, the process 400 may check for the received uplink frames in real-time or near-real time. In some more embodiments, the process 400 can check for the uplink frames that are scheduled to be received in the TXOP.

In many additional embodiments, if at block 460, the process 400 determines that the uplink frames from all the ambient power devices have not been received, the process 400 can loop back to block 450 to receive the next uplink frame. In some embodiments, the process 400 may continuously listen for the next uplink frames. In certain embodiments, the process 400 can ensure that the AP is responsive to incoming uplink frames and does not miss any uplink transmission from any ambient power device.

In many further embodiments, if at block 460, the process 400 determines that the uplink frames from all the ambient power devices have been received, the process 400 can transmit the multi-user bulk acknowledgement frame to the plurality of ambient power devices (block 470). In some embodiments, the process 400 may transmit a separate acknowledgement frame to each ambient power device in response to receiving the corresponding uplink frame. In certain embodiments, the process 400 can transmit a single acknowledgement frame, i.e., the multi-user bulk acknowledgement frame to multiple ambient power devices in response to receiving the corresponding uplink frames. In more embodiments, the acknowledgement frame or the multi-user acknowledgement frame can be indicative of the process 400 receiving the data transmitted by the multiple ambient power devices.

Although a specific embodiment for the process 400 for transmitting the control frames by the AP for carrying out the various steps, processes, methods, and operations described herein is discussed with respect to FIG. 4, any of a variety of systems and/or processes may be utilized in accordance with embodiments of the disclosure. For example, the process 400 may dynamically monitor and coordinate the uplink transmissions from the plurality of ambient power devices. The elements depicted in FIG. 4 may also be interchangeable with other elements of FIGS. 1-3 and FIGS. 5-7 as required to realize a particularly desired embodiment.

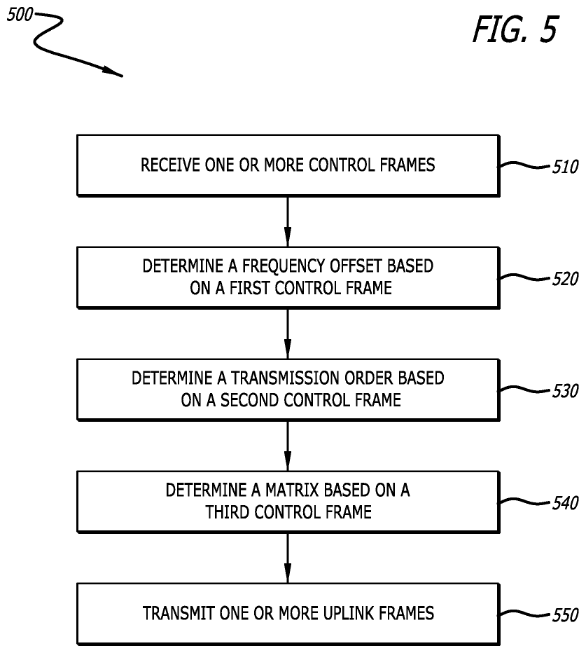

Referring now to FIG. 5, a flowchart depicting a process 500 for processing the control frames by the ambient power devices, in accordance with various embodiments of the disclosure is shown. In many embodiments, the process 500 can receive the one or more control frames from the AP (block 510). In some embodiments, the process 500 may be implemented by a single ambient power device or the one or more ambient power devices.

In a number of embodiments, the process 500 can determine the frequency offset based on a first control frame (block 520). In some embodiments, the first control frame may include the sequence of bits. In certain embodiments, the process 500 can determine the frequency offset based on the sequence of bits in the first control frame. In more embodiments, the sequence of bits can also be utilized by the process 500 to determine the phase offset. In many further embodiments, the process 500 may transmit the uplink frame at the frequency that is shifted from the carrier frequency based on the frequency offset. In that, in still many embodiments, different ambient power devices can transmit at different shifted frequencies based on different frequency offsets, thereby facilitating in reducing collisions between the different ambient power devices. In many more embodiments, for example, the different ambient power devices may reach the corresponding predetermined charge levels at same time, and hence, may be ready for transmission of the uplink frames at the same time. In that case, in still more embodiments, the collisions can be avoided by shifting the frequencies of the transmissions of the uplink frames.

In various embodiments, the process 500 may determine the transmission order based on the second control frame (block 530). In some embodiments, the second control frame may comprise the transmission order or can be indicative of the transmission order. In certain embodiments, the transmission order, in conjunction with the time slots and the one or more carrier frequencies, can be utilized by the process 500 to determine time of transmission of the uplink frames or the TXOP for the uplink transmission.

In additional embodiments, the process 500 can determine the matrix based on a third control frame (block 540). In some embodiments, the third control frame may comprise the matrix or can be indicative of the matrix. In certain embodiments, each element of the matrix may be indicative of a combination of a specific time slot and a specific carrier frequency or RF channel. In more embodiments, the matrix can be agreed upon beforehand, for example, the AP may transmit the matrix to the ambient power devices when the ambient power devices associate with the AP, or the matrix can be configured in the ambient power devices. In some more embodiments, the process 500 may dynamically receive the matrix from the AP. In numerous embodiments, the process 500 can receive the size of the matrix from the AP. In many further embodiments, the process 500 can select the one or more time slots and/or the one or more carrier frequencies based on the matrix or the size of the matrix.

In further embodiments, the process 500 may transmit the one or more uplink frames (block 550). In some embodiments, the process 500 can transmit the uplink frame based on the frequency offset derived from the first control frame. In certain embodiments, the process 500 may transmit the uplink frame based on the transmission order indicated by the second control frame. In more embodiments, the process 500 can transmit the uplink frame based on the matrix comprised in the third control frame.

Although a specific embodiment for the process 500 for processing the control frames by the ambient power devices for carrying out the various steps, processes, methods, and operations described herein is discussed with respect to FIG. 5, any of a variety of systems and/or processes may be utilized in accordance with embodiments of the disclosure. For example, the process 500 may coordinate the transmission in the frequency domain, the time domain, or the combination of the frequency and time domains. The elements depicted in FIG. 5 may also be interchangeable with other elements of FIGS. 1-4 and FIGS. 6-7 as required to realize a particularly desired embodiment.

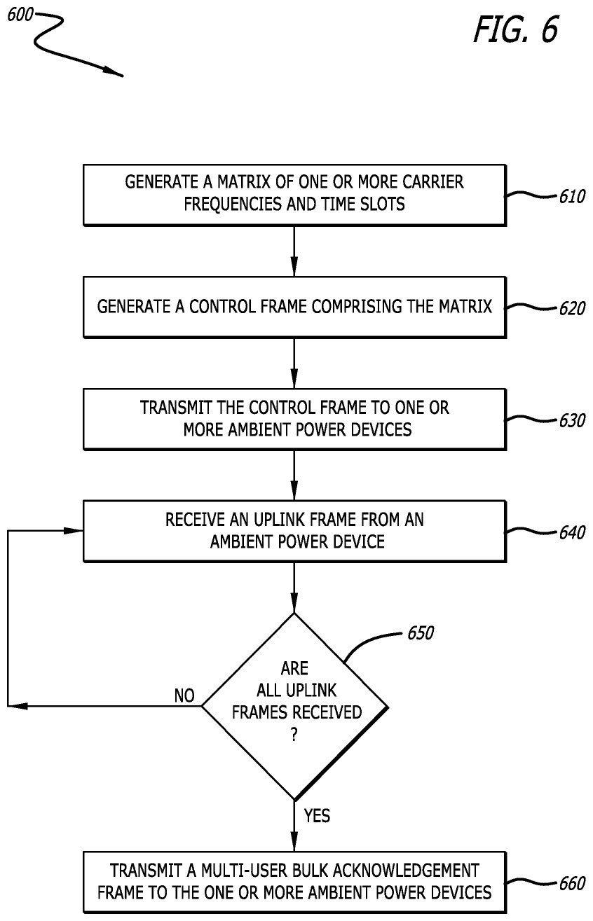

Referring now to FIG. 6, a flowchart depicting a process 600 for generating the matrix, in accordance with various embodiments of the disclosure is shown. In many embodiments, the process 600 can generate the matrix of the one or more carrier frequencies and time slots (block 610). In some embodiments, each element of the matrix may be indicative of a combination of the specific time slot and the specific carrier frequency or RF channel. In certain embodiments, the matrix can be agreed upon beforehand, for example, the process 600 may transmit the matrix to the ambient power devices when the ambient power devices associate with the AP, or the matrix can be configured in the ambient power devices. In more embodiments, the process 600 may dynamically generate the matrix and transmit the matrix to the ambient power devices. In some more embodiments, the process 600 can dynamically modify size or content of the matrix based on one or more dynamic changes in network topology or network conditions. In numerous embodiments, the process 600 may dynamically transmit the size of the matrix to the ambient power devices. In many further embodiments, the process 600 may transmit different sizes of the matrix to different ambient power devices to avoid collisions between the transmissions from the different ambient power devices. Similarly, the process 600 can group a set of ambient power devices and transmit the matrix or the size of the matrix to the set of ambient power devices. Further, the process 600 may transmit different sizes of the matrix to different sets of ambient power devices to avoid collisions between the transmissions from the different sets of ambient power devices. In some more embodiments, the process 600 can transmit a single matrix to multiple ambient power devices. In numerous embodiments, the process 600 may generate multiple matrices indicative of the carrier frequencies and the time slots. In many further embodiments, the process 600 can assign a different matrix to each ambient power device or to each set of ambient power devices. In still more embodiments, the process 600 may generate multiple control frames indicative of the matrices.

In a number of embodiments, the process 600 can generate the control frame comprising the matrix (block 620). In some embodiments, the control frame may comprise the matrix or may be indicative of the matrix. In certain embodiments, the control frame can comprise the size of the matrix or can be indicative of the size of the matrix. In more embodiments, the process 600 can generate a separate control frame for each ambient power device or for each set of ambient power devices. In some more embodiments, the process 600 may generate the single control frame for the plurality of ambient power devices.

In various embodiments, the process 600 may transmit the control frame to the one or more ambient power devices (block 630). In some embodiments, the process 600 may also transmit the sequence of bits in the control frame. In certain embodiments, the process 600 can also transmit the transmission order in the control frame.

In additional embodiments, the process 600 can receive the uplink frame from one of the plurality of ambient power devices (block 640). In some embodiments, the ambient power device can transmit the uplink frame by backscattering the received control frame. In certain embodiments, the ambient power device may utilize one or more techniques such as but not limited to LoRa backscatter, CSS modulation, or amplitude/phase modulation, or other such modulation techniques etc. for example to backscatter and transmit the uplink frame.

In further embodiments, the process 600 can check if the uplink frames from all the ambient power devices have been received (block 650). In some embodiments, the process 600 may associate the received uplink frame with one of the plurality of ambient power devices based on the transmission order in the TXOP. Thereafter, in certain embodiments, the process 600 can determine which of the plurality of ambient power devices have not yet transmitted the corresponding uplink frames. In more embodiments, the process 600 may check for the received uplink frames in real-time or near-real time. In some more embodiments, the process 600 can check for the uplink frames that are scheduled to be received in the TXOP.

In many additional embodiments, if at block 650, the process 600 determines that the uplink frames from all the ambient power devices have not been received, the process 600 can loop back to block 640 to receive the next uplink frame. In some embodiments, the process 600 may continuously listen for the next uplink frames. In certain embodiments, the process 600 can ensure that the AP is responsive to incoming uplink frames and does not miss any uplink transmission from any ambient power device.

In many further embodiments, if at block 650, the process 600 determines that the uplink frames from all the ambient power devices have been received, the process 600 can transmit the multi-user bulk acknowledgement frame to the plurality of ambient power devices (block 660). In some embodiments, the process 600 may transmit the separate acknowledgement frame to each ambient power device in response to receiving the corresponding uplink frame. In certain embodiments, the process 600 can transmit the single acknowledgement frame, i.e., the multi-user bulk acknowledgement frame to multiple ambient power devices in response to receiving the corresponding uplink frames. In more embodiments, the acknowledgement frame or the multi-user acknowledgement frame can be indicative of the process 600 receiving the data transmitted by the multiple ambient power devices.

Although a specific embodiment for the process 600 for generating the matrix for carrying out the various steps, processes, methods, and operations described herein is discussed with respect to FIG. 6, any of a variety of systems and/or processes may be utilized in accordance with embodiments of the disclosure. For example, the process 600 may dynamically modify or change the matrix based on the dynamic changes in the network conditions or topology of the ambient power devices. The elements depicted in FIG. 6 may also be interchangeable with other elements of FIGS. 1-5 and FIG. 7 as required to realize a particularly desired embodiment.

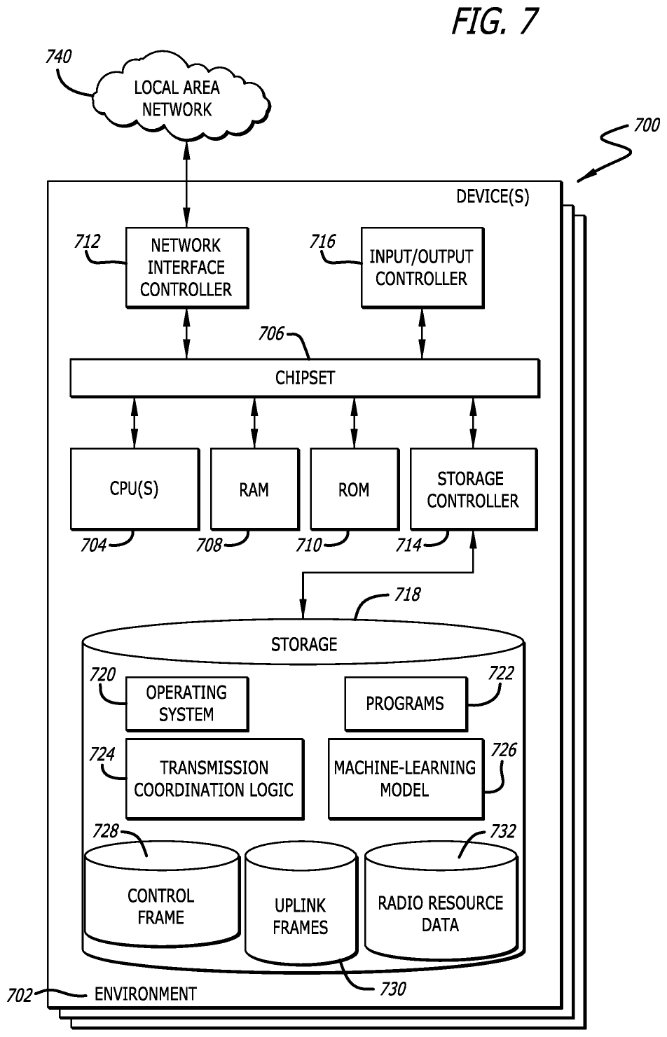

Referring to FIG. 7, a conceptual block diagram of a device 700 suitable for configuration with a transmission coordination logic, in accordance with various embodiments of the disclosure is shown. The embodiment of the conceptual block diagram depicted in FIG. 7 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 7 can also illustrate an access point, a switch, or a router in accordance with various embodiments of the disclosure. The device 700 may, in many non-limiting examples, correspond to physical devices or to virtual resources described herein.

In many embodiments, the device 700 may include an environment 702 such as a baseboard or “motherboard,” in physical embodiments that can be configured as a printed circuit board with a multitude of components or devices connected by way of a system bus or other electrical communication paths. Conceptually, in virtualized embodiments, the environment 702 may be a virtual environment that encompasses and executes the remaining components and resources of the device 700. In more embodiments, one or more processors 704, such as, but not limited to, central processing units (“CPUs”) can be configured to operate in conjunction with a chipset 706. The processor(s) 704 can be standard programmable CPUs that perform arithmetic and logical operations necessary for the operation of the device 700.

In a number of embodiments, the processor(s) 704 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 706 may provide an interface between the processor(s) 704 and the remainder of the components and devices within the environment 702. The chipset 706 can provide an interface to a random-access memory (“RAM”) 708, which can be used as the main memory in the device 700 in some embodiments. The chipset 706 can further be configured to provide an interface to a computer-readable storage medium such as a read-only memory (“ROM”) 710 or non-volatile RAM (“NVRAM”) for storing basic routines that can help with various tasks such as, but not limited to, starting up the device 700 and/or transferring information between the various components and devices. The ROM 710 or NVRAM can also store other application components necessary for the operation of the device 700 in accordance with various embodiments described herein.

Additional embodiments of the device 700 can be configured to operate in a networked environment using logical connections to remote computing devices and computer systems through a network, such as the network 740. The chipset 706 can include functionality for providing network connectivity through a network interface card (“NIC”) 712, which may comprise a gigabit Ethernet adapter or similar component. The NIC 712 can be capable of connecting the device 700 to other devices over the network 740. It is contemplated that multiple NICs 712 may be present in the device 700, connecting the device to other types of networks and remote systems.

In further embodiments, the device 700 can be connected to a storage 718 that provides non-volatile storage for data accessible by the device 700. The storage 718 can, for instance, store an operating system 720, applications 722, control frame 728, uplink frames 730, and radio resource data 732 which are described in greater detail below. The storage 718 can be connected to the environment 702 through a storage controller 714 connected to the chipset 706. In certain embodiments, the storage 718 can consist of one or more physical storage units. The storage controller 714 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The control frame 728 can store the control frame generated by the device 700 and transmitted to the plurality of ambient power devices. The uplink frames 730 may store the uplink frames received from the plurality of ambient power devices. The radio resource data 732 may store information about one or more of: the carrier frequencies, the time slots, or the one or more matrices generated by the device 700.

The device 700 can store data within the storage 718 by transforming the physical state of the physical storage units to reflect the information being stored. The specific transformation of physical state can depend on various factors. Examples of such factors can include, but are not limited to, the technology used to implement the physical storage units, whether the storage 718 is characterized as primary or secondary storage, and the like.

In many more embodiments, the device 700 can store information within the storage 718 by issuing instructions through the storage controller 714 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 700 can further read or access information from the storage 718 by detecting the physical states or characteristics of one or more particular locations within the physical storage units.

In addition to the storage 718 described above, the device 700 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 700. In some examples, the operations performed by a cloud computing network, and or any components included therein, may be supported by one or more devices similar to device 700. Stated otherwise, some or all of the operations performed by the cloud computing network, and or any components included therein, may be performed by one or more devices 700 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 718 can store an operating system 720 utilized to control the operation of the device 700. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 718 can store other system or application programs and data utilized by the device 700.

In many additional embodiments, the storage 718 or other computer-readable storage media is encoded with computer-executable instructions which, when loaded into the device 700, may transform it from a general-purpose computing system into a special-purpose computer capable of implementing the embodiments described herein. These computer-executable instructions may be stored as application 722 and transform the device 700 by specifying how the processor(s) 704 can transition between states, as described above. In some embodiments, the device 700 has access to computer-readable storage media storing computer-executable instructions which, when executed by the device 700, perform the various processes described above with regard to FIGS. 1-6. In certain embodiments, the device 700 can also include computer-readable storage media having instructions stored thereupon for performing any of the other computer-implemented operations described herein.

In many further embodiments, the device 700 may include a transmission coordination logic 724. The transmission coordination logic 724 can be configured to perform one or more of the various steps, processes, operations, and/or other methods that are described above. Often, the transmission coordination logic 724 can be a set of instructions stored within a non-volatile memory that, when executed by the processor(s)/controller(s) 704 can carry out these steps, etc. In some embodiments, the transmission coordination logic 724 may be a client application that resides on a network-connected device, such as, but not limited to, a server, switch, personal or mobile computing device in a single or distributed arrangement. The transmission coordination logic 724 can coordinate the uplink transmissions from the plurality of ambient power devices.

In still further embodiments, the device 700 can also include one or more input/output controllers 716 for receiving and processing input from a number of input devices, such as a keyboard, a mouse, a touchpad, a touch screen, an electronic stylus, or other type of input device. Similarly, an input/output controller 716 can be configured to provide output to a display, such as a computer monitor, a flat panel display, a digital projector, a printer, or other type of output device. Those skilled in the art will recognize that the device 700 might not include all of the components shown in FIG. 7 and can include other components that are not explicitly shown in FIG. 7 or might utilize an architecture completely different than that shown in FIG. 7.

As described above, the device 700 may support a virtualization layer, such as one or more virtual resources executing on the device 700. In some examples, the virtualization layer may be supported by a hypervisor that provides one or more virtual machines running on the device 700 to perform functions described herein. The virtualization layer may generally support a virtual resource that performs at least a portion of the techniques described herein.

Finally, in numerous additional embodiments, data may be processed into a format usable by a machine-learning model 726 (e.g., feature vectors), and or other pre-processing techniques. The machine-learning (“ML”) model 726 may be any type of ML model, such as supervised models, reinforcement models, and/or unsupervised models. The ML model 726 may include one or more of linear regression models, logistic regression models, decision trees, Naïve Bayes models, neural networks, k-means cluster models, random forest models, and/or other types of ML models 726.

The ML model(s) 726 can be configured to generate inferences to make predictions or draw conclusions from data. An inference can be considered the output of a process of applying a model to new data. This can occur by learning from at least the control frame 728, the uplink frames 730, and the radio resource data 732 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 726 may be generated by human/administrator verifications or may compare predicted outcomes with actual outcomes.

Although a specific embodiment for the device 700 suitable for configuration with the transmission coordination logic for carrying out the various steps, processes, methods, and operations described herein is discussed with respect to FIG. 7, any of a variety of systems and/or processes may be utilized in accordance with embodiments of the disclosure. For example, the device 700 may be in a virtual environment such as a cloud-based network administration suite, or it may be distributed across a variety of network devices or switches. The elements depicted in FIG. 7 may also be interchangeable with other elements of FIGS. 1-6 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a transmission coordination logic, configured to:
determine one or more carrier frequencies;
determine one or more time slots associated with the one or more carrier frequencies;
generate a control frame based on the one or more carrier frequencies or the one or more time slots; and
transmit the control frame to one or more ambient power devices.

2. The device of claim 1, wherein the transmission coordination logic is further configured to receive one or more uplink frames from the one or more ambient power devices in response to the control frame.

3. The device of claim 2, wherein the transmission coordination logic is further configured to transmit a multi-user bulk acknowledgement frame to the one or more ambient power devices in response to the one or more uplink frames.

4. The device of claim 2, wherein each ambient power device of the one or more ambient power devices determines a frequency offset based on the control frame and transmits an uplink frame of the one or more uplink frames based on the frequency offset.

5. The device of claim 2, wherein the one or more ambient power devices transmit the one or more uplink frames by backscattering the control frame.

6. The device of claim 2, wherein the one or more ambient power devices are energized or triggered by the control frame to transmit the one or more uplink frames.

7. The device of claim 2, wherein the transmission coordination logic is further configured to determine a transmission order based on the one or more time slots, wherein the control frame comprises the transmission order.

8. The device of claim 7, wherein each ambient power device of the one or more ambient power devices transmits an uplink frame of the one or more uplink frames based on the transmission order.

9. The device of claim 2, wherein the transmission coordination logic is further configured to generate a matrix of the one or more carrier frequencies and the one or more time slots, wherein the control frame comprises the matrix.

10. The device of claim 9, wherein the one or more ambient power devices transmit the one or more uplink frames based on the matrix.

11. The device of claim 2, wherein the transmission coordination logic is further configured to:
generate one or more matrices indicative of the one or more carrier frequencies and the one or more time slots;
assign a matrix of the one or more matrices to an ambient power device of the one or more ambient power devices;
generate one or more control frames comprising the one or more matrices; and
transmit the control frame of the one or more control frames to corresponding ambient power device of the one or more ambient power devices.

12. The device of claim 11, wherein each ambient power device of the one or more ambient power devices transmits an uplink frame of the one or more uplink frames based on corresponding matrix of the one or more matrices.

13. The device of claim 2, wherein each ambient power device of the one or more ambient power devices selects a carrier frequency of the one or more carrier frequencies for transmitting an uplink frame of the one or more uplink frames based on a random value.

14. The device of claim 2, wherein each ambient power device of the one or more ambient power devices selects a carrier frequency of the one or more carrier frequencies for transmitting an uplink frame of the one or more uplink frames based on a predetermined hash value.

15. A device, comprising:
a processor;
a memory communicatively coupled to the processor; and
a transmission coordination logic, configured to:
generate a matrix of one or more carrier frequencies and one or more time slots;
generate a control frame comprising the matrix; and
transmit the control frame to one or more ambient power devices.

16. The device of claim 15, wherein each ambient power device of the one or more ambient power devices transmits an uplink frame in response to the control frame based on the matrix.

17. The device of claim 15, wherein the transmission coordination logic is further configured to determine a transmission order based on the one or more time slots, wherein the control frame is indicative of the transmission order.

18. The device of claim 17, wherein each ambient power device of the one or more ambient power devices transmits an uplink frame based on the transmission order.

19. A method comprising:
determining one or more carrier frequencies;
determining one or more time slots associated with the one or more carrier frequencies;
generating a control frame based on the one or more carrier frequencies or the one or more time slots; and
transmitting the control frame to one or more ambient power devices.

20. The method of claim 19, further comprising:
receiving one or more uplink frames from the one or more ambient power devices in response to the control frame; and
transmitting a multi-user bulk acknowledgement frame to the one or more ambient power devices in response to the one or more uplink frames.
